(19) United States
(12) Patent Application Publication
(10) Pub. No.: US 2006/0121786 A1
(43) Pub. Date: Jun. 8, 2006

(54) Adapter having efficiently positioning effect

(76) Inventors: Chung-Chen Feng, Sinjhuang City (TW); Ching - Wen Chen, Taipei City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/247,910

(22) Filed: Oct. 11, 2005

(30) Foreign Application Priority Data
Dec. 8, 2004 (TW) 093219728

(51) Int. Cl. H01R 9/03

(52) U.S. Cl. 439/610

(57) ABSTRACT

An adapter includes a metallic connector having a mounting recess, a metallic hose having an end portion inserted into the mounting recess of the metallic connector, and at least one fusible metal ring located between the end portion of the metallic hose and the mounting recess of the metallic connector. Thus, the metallic connector and the metallic hose are combined together rigidly and stably by the fixing portion formed by the fusible metal ring, so that the adapter has a reinforced strength and solidified structure. In addition, the metallic connector and the metallic hose are combined together closely, so that the metallic hose will not detach from the metallic connector during a long-term utilization, thereby enhancing the lifetime of the adapter.

### BACKGROUND OF THE INVENTION

1. Field of the Invention

The present invention relates to an adapter, and more particularly to an adapter having an efficiently positioning effect.

2. Description of the Related Art

A conventional adapter comprises a metallic connector having an end portion formed with a mounting recess, a metallic hose having an end portion inserted into the mounting recess of the metallic connector, and an adhesive coated around the end portion of the metallic hose and adhered to the mounting recess of the metallic connector to secure the end portion of the metallic hose to the metallic connector. However, the adhesive is easily loosened during a long-term utilization, so that the metallic hose and the metallic connector are not combined rigidly and stably by the adhesive.

Another conventional adapter in accordance with the prior art shown in FIGS. 8 and 9 comprises a metallic hose 3, and a metallic connector 4 having an end portion formed with a press portion 42 pressed on an end portion of the metallic hose 3 to combine the metallic hose 3 with the metallic connector 4. However, the metallic connector 4 is formed with the press portion 42 by a press, thereby increasing costs of fabrication. In addition, the press portion 42 of the metallic connector 4 is easily loosened from the metallic hose 3 during a long-term utilization, thereby decreasing the lifetime of the adapter, and thereby causing inconvenience to the user. Further; the press portion 42 of the metallic connector 4 is deformed or distorted by the press, thereby decreasing the aesthetic quality of the adapter.

### SUMMARY OF THE INVENTION

In accordance with the present invention, there is provided an adapter, comprising adapter, comprising a metallic connector having an end portion formed with a mounting recess, a metallic hose having an end portion inserted into the mounting recess of the metallic connector, and at least one fusible metal ring located between the end portion of the metallic hose and the mounting recess of the metallic connector to secure the end portion of the metallic hose to the metallic connector.

The primary objective of the present invention is to provide an adapter having an efficiently positioning effect.

Another objective of the present invention is to provide an adapter, wherein the metallic connector and the metallic hose are combined together rigidly and stably by the fixing portion formed by the fusible metal ring, so that the adapter has a reinforced strength and solidified structure.

A further objective of the present invention is to provide an adapter, wherein the metallic connector and the metallic hose are combined together closely, so that the metallic hose will not detach from the metallic connector during a long-term utilization, thereby enhancing the lifetime of the adapter.

A further objective of the present invention is to provide an adapter, wherein the metallic connector and the metallic hose are combined together easily and rapidly, so that the adapter is worked easily and conveniently.

A further objective of the present invention is to provide an adapter, wherein the metallic connector and the metallic hose are combined together by the fixing portion formed by the fusible metal ring without needing a press working process, thereby enhancing the aesthetic quality of the adapter.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away exploded perspective view of an adapter in accordance with the preferred embodiment of the present invention.

FIG. 2 is a plan cross-sectional assembly view of the adapter as shown in FIG. 1.

FIG. 3 is a partially cut-away perspective view of the adapter in accordance with the preferred embodiment of the present invention.

FIG. 4 is a plan cross-sectional view of the adapter as shown in FIG. 3.

FIG. 5 is a partially cut-away plan cross-sectional view of an adapter in accordance with another preferred embodiment of the present invention.

FIG. 6 is a plan cross-sectional view of the adapter as shown in FIG. 5.

FIG. 7 is a partially cut-away plan cross-sectional view of an adapter in accordance with another preferred embodiment of the present invention.

FIG. 8 is a partially cut-away perspective view of a conventional adapter in accordance with the prior art.

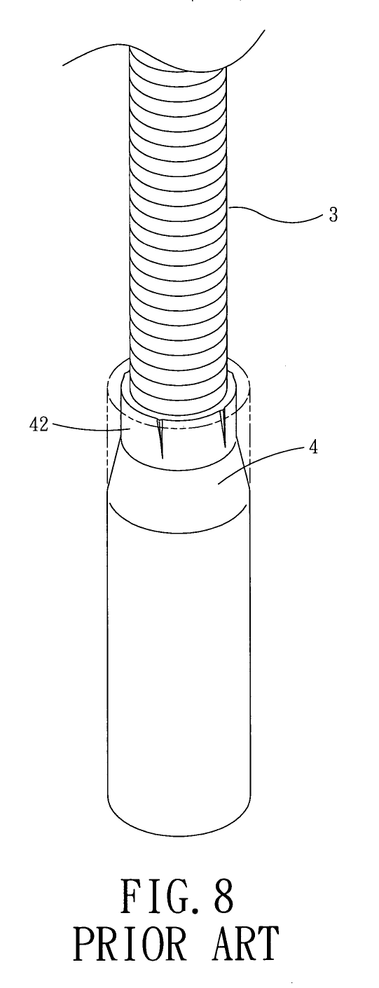

FIG. 9 is a plan cross-sectional view of the conventional adapter as shown in FIG. 8.

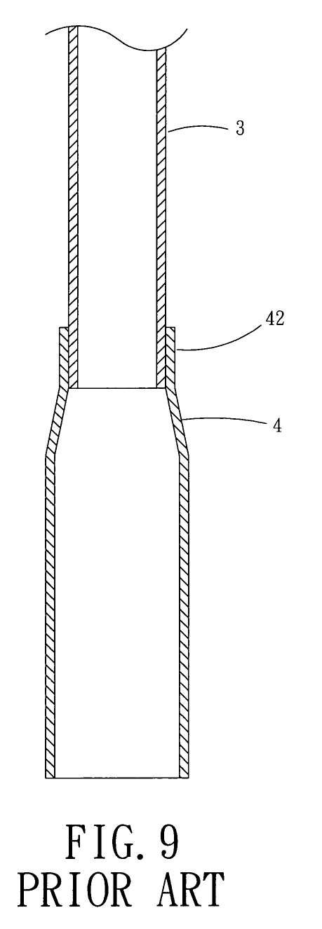

### DETAILED DESCRIPTION OF THE INVENTION

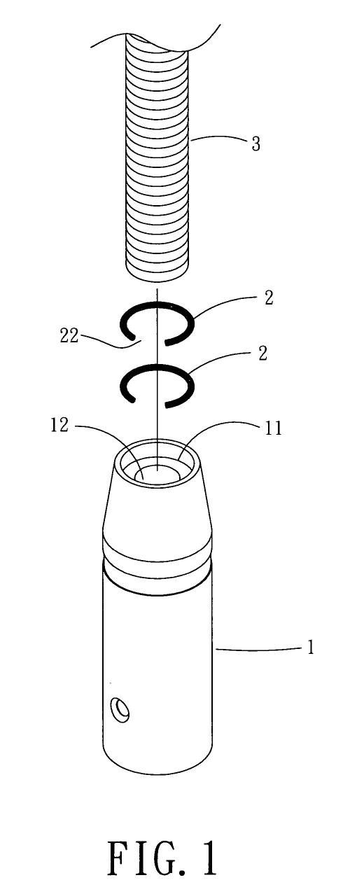

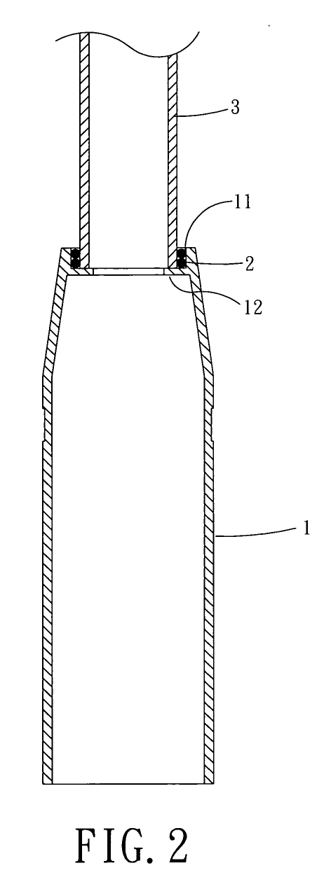

Referring to the drawings and initially to FIGS. 1 and 2, an adapter in accordance with the preferred embodiment of the present invention comprises a metallic connector 1 having an end portion formed with a mounting recess 11, a metallic hose 3 having an end portion inserted into the mounting recess 11 of the metallic connector 1, and at least one fusible metal ring 2 located between the end portion of the metallic hose 3 and the mounting recess 11 of the metallic connector 1 to secure the end portion of the metallic hose 3 to the metallic connector 1.

The metallic connector 1 is a housing of an article to be connected, such as a microphone or the like. The mounting recess 11 of the metallic connector 1 has a bottom formed with an annular flange 12 to stop the end portion of the metallic hose 3.

The fusible metal ring 2 is substantially C-shaped and has two ends with an opening 22 defined therebetween. The fusible metal ring 2 has a relatively lower melting point so that the fusible metal ring 2 is melted easily. The fusible metal ring 2 is mounted on the end portion of the metallic hose 3 and extended into the mounting recess 11 of the metallic connector 1. Preferably, the fusible metal ring 2 is mounted around a periphery of the end portion of the metallic hose 3.

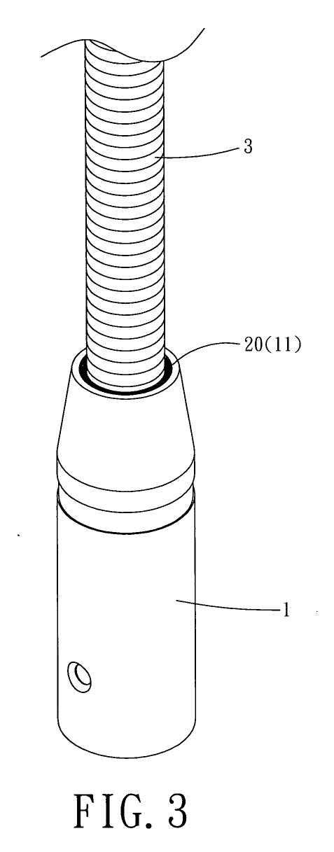

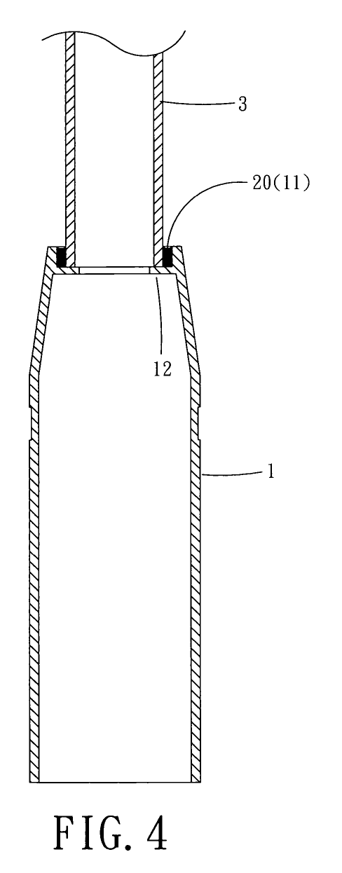

Referring to FIGS. 3 and 4, the fusible metal ring 2 is melted by heating to form a fixing portion 20 filled between the end portion of the metallic hose 3 and the mounting recess 11 of the metallic connector 1 after the melted fusible metal ring 2 is solidified to secure the end portion of the metallic hose 3 to the metallic connector 1 so that the metallic connector 1 and the metallic hose 3 are combined together rigidly and stably by the fixing portion 20 formed by the fusible metal ring 2.

Accordingly, the metallic connector 1 and the metallic hose 3 are combined together rigidly and stably by the fixing portion 20 formed by the fusible metal ring 2, so that the adapter has a reinforced strength and solidified structure. In addition, the metallic connector 1 and the metallic hose 3 are combined together closely, so that the metallic hose 3 will not detach from the metallic connector 1 during a long-term utilization, thereby enhancing the lifetime of the adapter. Further, the metallic connector 1 and the metallic hose 3 are combined together easily and rapidly, so that the adapter is worked easily and conveniently. Further, the metallic connector 1 and the metallic hose 3 are combined together by the fixing portion 20 formed by the fusible metal ring 2 without needing a press working process, thereby enhancing the aesthetic quality of the adapter.

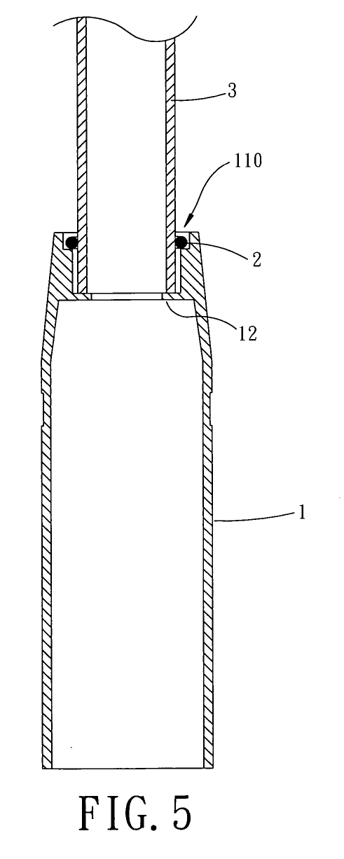

Referring to FIG. 5, the mounting recess 110 of the metallic connector 1 is a stepped hole having a reduced diameter to prevent the metallic hose 3 from being vibrated when the end portion of the metallic hose 3 is inserted into the mounting recess 110 of the metallic connector 1. In addition, the fusible metal ring 2 has a substantially circular cross-sectional profile.

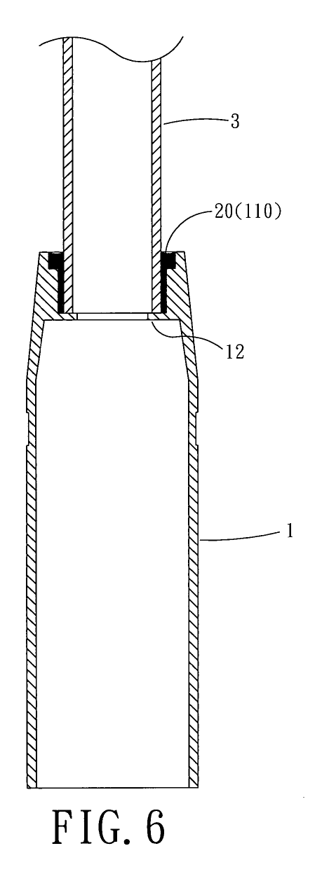

Referring to FIG. 6, the fusible metal ring 2 is melted by heating to form a fixing portion 20 filled between the end portion of the metallic hose 3 and the mounting recess 110 of the metallic connector 1 after the melted fusible metal ring 2 is solidified to secure the end portion of the metallic hose 3 to the metallic connector 1 so that the metallic connector 1 and the metallic hose 3 are combined together rigidly and stably by the fixing portion 20 formed by the fusible metal ring 2. Preferably, the fixing portion 20 formed by the fusible metal ring 2 has a substantially inverted L-shaped cross-sectional profile.

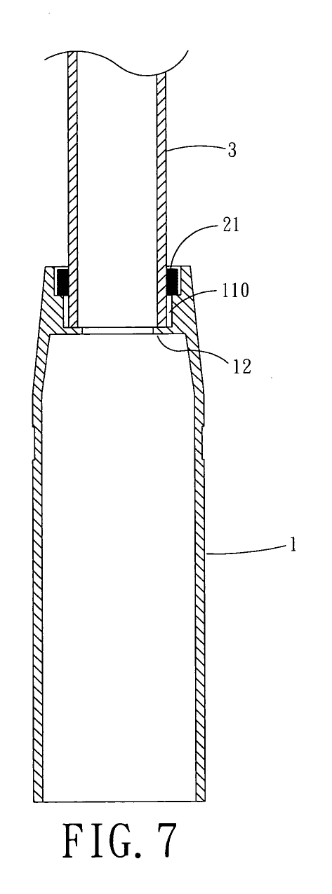

Referring to FIG. 7, the fusible metal ring 21 has a substantially rectangular cross-sectional profile.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An adapter, comprising:
a metallic connector having an end portion formed with a mounting recess;
a metallic hose having an end portion inserted into the mounting recess of the metallic connector;
at least one fusible metal ring located between the end portion of the metallic hose and the mounting recess of the metallic connector to secure the end portion of the metallic hose to the metallic connector.

2. The adapter in accordance with claim 1, wherein the mounting recess of the metallic connector has a bottom formed with an annular flange to stop the end portion of the metallic hose.

3. The adapter in accordance with claim 1, wherein the fusible metal ring is substantially C-shaped.

4. The adapter in accordance with claim 1, wherein the fusible metal ring has two ends with an opening defined therebetween.

5. The adapter in accordance with claim 1, wherein the fusible metal ring has a relatively lower melting point so that the fusible metal ring is melted easily.

6. The adapter in accordance with claim 1, wherein the fusible metal ring is mounted on the end portion of the metallic hose and extended into the mounting recess of the metallic connector.

7. The adapter in accordance with claim 1, wherein the fusible metal ring is mounted around a periphery of the end portion of the metallic hose.

8. The adapter in accordance with claim 1, wherein the fusible metal ring is melted by heating to form a fixing portion filled between the end portion of the metallic hose and the mounting recess of the metallic connector after the melted fusible metal ring is solidified to secure the end portion of the metallic hose to the metallic connector so that the metallic connector and the metallic hose are combined together by the fixing portion formed by the fusible metal ring.

9. The adapter in accordance with claim 1, wherein the mounting recess of the metallic connector is a stepped hole.

10. The adapter in accordance with claim 9, wherein the mounting recess of the metallic connector has a reduced diameter.

11. The adapter in accordance with claim 1, wherein the fusible metal ring has a substantially circular cross-sectional profile.

12. The adapter in accordance with claim 8, wherein the fixing portion formed by the fusible metal ring has a substantially inverted L-shaped cross-sectional profile.

13. The adapter in accordance with claim 1, wherein the fusible metal ring has a substantially rectangular cross-sectional profile.
